(19) United States
(12) Patent Application Publication
(10) Pub. No.: US 2010/0303429 A1
(43) Pub. Date: Dec. 2, 2010

(54) Microstructured Optical Fiber Draw Method with In-Situ Vacuum Assisted Preform Consolidation

(75) Inventors: Daniel J. Gibson, Greenbelt, MD (US); Jasbinder S. Sanghera, Ashburn, VA (US); Frederic H. Kung, Alexandria, VA (US); Ishwar D. Aggarwal, Fairfax Station, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(73) Assignee: The Government of the United States of America, as represented by the Secretary of the Navy, Washington, DC (US)

(21) Appl. No.: 12/471,668

(22) Filed: May 26, 2009

(51) Int. Cl. G02B 6/032; G02B 6/036; C03B 37/02; C03B 37/075

(52) U.S. Cl. 385/125; 385/128; 65/393

(57) ABSTRACT

A method and apparatus for making a substantially void-free microstructured optical fiber using a one-step process is provided. A preform for the optical fiber is prepared, comprising an outer jacket made of solid glass, a cladding having a plurality of microtubes and/or microcanes arranged in a desired pattern within the jacket, and a core which may be solid or hollow, with the cladding and the core extending above the top of the outer jacket. The thus-prepared preform is placed into a fiber draw tower. As the fiber is drawn, negative gas pressure is applied to draw the canes together and consolidate the interfacial voids between the canes while positive gas pressure is applied to the preform to keep the holes of the microcanes open during the fiber drawing. The apparatus includes a jig having support tubes that are connected to a vacuum pump for application of the negative gas pressure and a vent tube connected to a gas supply for application of the positive gas pressure. The interfaces between the support tube and the outer jacket and between the vent tube and the cladding are sealed to ensure that the appropriate application of negative or positive pressure during the draw step is obtained. The preforms according to the present invention can include one or more components fabricated from specialty non-silica glass.

### TECHNICAL FIELD

The present invention relates to microstructured optical fibers and methods for making the same.

### BACKGROUND

Optical fibers have found increasing uses in industrial, scientific, and military applications. Conventional optical fibers guide light passing through them using the principles of total internal reflection. Total internal reflection (TIR) occurs when light travels through a material having a high index of refraction n and strikes an interface between that material and a material having a lower value of n. If the angle of incidence of the light on the interface is greater than some angle, known as the “critical angle” θ_{c}, the light cannot pass through the interface into the lower-refractive material but instead is reflected back into the higher-refractive material. Thus, for optical glass fibers, the principle of total internal reflection requires that the inner core of the fiber have a higher index of refraction than the outer cladding. However, due to the nature of the materials used, such conventional fibers still exhibit some absorption and scattering of the light traveling through them and can therefore suffer some loss as the signal travels through the fiber.

More recently, microstructured optical fibers have been developed in an attempt to improve the transmission and reduce the leakage of light traveling therethrough. These microstructured optical fibers include solid core photonic crystal fibers (SC-PCF) and hollow core photonic band gap (HC-PBG) fibers. Like conventional optical fibers, both SC-PCF and HC-PBG fibers have a three-layer structure comprising a core area, an intermediate cladding surrounding the core area, and a jacket made of solid glass surrounding the cladding. However, in both SC-PCF and HC-PBG fibers, the cladding is not solid as in conventional optical fibers, but instead comprises a microstructured region having a periodic arrangement of glass and holes, which confines the light to the core of the fiber.

In SC-PCFs, the core area is solid, and the confinement mechanism is similar to that of conventional TIR fibers, in that the cladding has a lower average refractive index than the solid core due to the presence of air holes in the glass. One benefit SC-PCFs have when compared to conventional fibers is that single mode operation can readily be obtained simultaneously for a large range of wavelengths, rather than for a single wavelength (or very narrow band of wavelengths) as in conventional TIR fibers. This is primarily due to the wavelength dependence of the refractive effective index of the lowest order mode. See e.g., T. A. Birks et al., “Endlessly single-mode photonic crystal fiber,” Optics Letters, Vol. 22, pp. 961-963 (1997) (describing guidance in and design of PCF fibers). In addition to being “endlessly single-mode,” these fibers can also have very high nonlinearity and other useful properties.

In contrast, HC-PBG fibers have a hollow core, and operate on the principle of two-dimensional photonic bandgap confinement, a condition which prohibits the propagation of specific wavelengths within the photonic bandgap cladding region. The existence of a photonic bandgap is governed by the wavelength of interest, and the transverse dielectric function of the fiber. The transverse dielectric function describes the refractive index of a cross-section of the fiber and is governed by the refractive index of the glass, the shape and location of the holes, the hole diameter and pitch (the ratio of which governs the air fill fraction) and the lattice arrangement (i.e., triangular, square, etc.) Since the light in HC-PBG fibers is confined primarily to the air void and not the glass as in conventional TIR fibers, both signal loss and light-induced fiber damage are reduced. This enables HC-PBG fibers to transmit higher energy signals over longer distances.

Microstructured optical fibers have been fabricated from silica and other glasses, and their design and manufacture have been described in the literature. For example, see S. Barkou et al., “Silica-air photonic crystal fiber design that permits waveguiding by a true photonic bandgap effect,” Optics Letters, Vol. 24, No. 1, pp. 46-48 (1999) (describing silica glass fiber having air holes arranged in a honeycomb pattern with an additional central air hole in which light having specific wavelengths can be confined); N. Venkataraman, et al., “Low loss (13 dB/km) air core photonic band-gap fibre,” ECOC, Postdeadline Paper PD1.1, September, 2002 (describing low signal loss properties of silica glass HC-PBG fibers); and P. Russell, “Photonic Crystal Fibers,” Science, Vol. 299, No. 3, pp 358-362 (2003) (describing silica glass photonic crystal fibers in general).

Such microstructured optical fibers are typically made using a preform comprising an outer shell and a number of hollow tubes arranged in a periodic structure, with either a hollow (HC-PBG) or solid (SC-PCF) core. See e.g., R. F. Cregan, et al., “Single-mode photonic band gap guidance of light in air,” Science, Vol. 285, pp. 1537-1539 (1999) (describing photonic band gap (PBG) guidance of light through optical fiber comprising tubes of silica glass arranged in a periodic pattern); and U.S. Pat. No. 6,847,771 (describing microstructured optical fibers and fabrication of such fibers from optical fiber preforms).

Microstructured optical fibers also can be made from non-silica glass such as chalcogenide glasses. See, e.g., U.S. Patent Application Publication No. 2005/0074215; U.S. Patent Application Publication No. 2006/0230792; and U.S. Pat. No. 7,295,740, each of which shares at least one inventor in common with the present invention.

A microstructured optical fiber is typically made using a preform which is then drawn into the final fiber. In the preform, a number of glass microtubes or microcanes are placed in a periodic arrangement between the core and the outer jacket to form the cladding. Such microtubes are hollow tubes having an opening, i.e., a hole, extending through their entire length, while microcanes may be solid or hollow. The arrangement of the microtubes and/or microcanes creates a periodic structure of glass and holes in the cladding which affects the transmission of light therethrough. The preform is then drawn to create the optical fiber.

However, because the microtubes and/or microcanes comprising the cladding do not always fit together perfectly, there may be gaps, or voids, at the interfaces between the microtubes/microcanes or between the cladding area and the outer jacket. Such “interfacial voids” extend longitudinally through the entire length of the preform and are connected to the ambient atmosphere outside the preform via the preform ends. Many of these voids can be eliminated during the fiber drawing or other heat treatment step as the tubes are drawn closer together, but often some of these voids remain as “interstitial voids.” These interstitial voids are not connected to the atmosphere outside the fiber but are trapped within the fiber.

The presence of both the interfacial and interstitial voids is undesirable. The interfacial voids run the entire length of the preform and have a size similar to that of the intended holes in the structured region and so can make fiberization difficult. Furthermore, the accuracy of the periodicity and position of the intended holes is critical to the desired optical properties of the microstructured fiber, and the presence of such “stray” holes in the fiber can destroy the ability of the fiber to perform properly.

Conventional processes attempt to reduce or eliminate the number of such interstitial voids by using a two-step process, in which the tubes in the preform are consolidated prior to fiber drawing. However, this two-step process still leaves an undesirable number of interstitial voids in the finished fiber.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present invention provides a method and an apparatus for making a substantially void-free microstructured optical fiber using a one-step process. In the method of the present invention, a preform for the optical fiber is prepared, comprising an outer jacket made of solid glass, a cladding having a plurality of microtubes and/or microcanes arranged in a desired pattern within the jacket, and a core which may be solid or hollow, with the cladding and the core extending above the top of the outer jacket. The thus-prepared preform is placed into a fiber draw tower configured according to the present invention. As the fiber is drawn, negative gas pressure is applied to draw the canes together and consolidate the interfacial voids between the canes while positive gas pressure is applied to the preform to keep the holes of the microcanes open during the fiber drawing. Thus, the final microstructured fiber can be prepared in one step, with the consolidation of the interfacial voids being accomplished sequentially in-situ as the preform is drawn into the SC-PCF or HC-PBG fiber, thereby preventing the creation of interstitial voids in the drawn fiber.

An apparatus for use in the present invention includes a fiber draw tower having a jig comprising one or more support tubes that are connected to a vacuum pump for application of the negative gas pressure and a vent tube connected to a gas supply for application of the positive gas pressure. The interfaces between the support tube and the outer jacket and between the vent tube and the cladding are sealed to ensure that the appropriate application of negative or positive pressure during the draw step is obtained.

The preforms according to the present invention can include one or more components fabricated from specialty non-silica glass, such as chalcogenide and chalcohalide glasses and other oxide glasses including specialty silicates, germanates, phosphates, borates, gallates, tellurites, antimonates and their mixtures.

### BRIEF DESCRIPTION OF THE DRAWINGS

FIGS. 1A and 1B are block diagrams showing aspects of the cross-sectional structure of an exemplary solid core photonic crystal fiber (SC-PCF) and an exemplary hollow core photonic band gap (HC-PBG) fiber described herein.

FIG. 2 is a block diagram showing an exemplary photonic crystal fiber preform used to prepare a microstructured optical fiber.

FIGS. 3A and 3B are micrographs showing the presence of interstitial voids in microstructured optical fibers prepared according to the prior art.

FIGS. 4A and 4B are block diagrams depicting exemplary embodiments of SC-PCF preforms suitable for use in the method of the present invention.

FIGS. 5A and 5B are block diagrams depicting exemplary embodiments of HC-PBG fiber preforms suitable for use in the method of the present invention.

FIG. 6 is a block diagram showing an exemplary apparatus for optical fiber drawing with in-situ vacuum-assisted preform consolidation according to the method of the present invention.

FIG. 7 is a block diagram of a first exemplary embodiment of an in-situ vacuum-assisted preform consolidation of an optical fiber according to the method of the present invention.

FIG. 8 is a block diagram of a second exemplary embodiment of an in-situ vacuum-assisted preform consolidation of an optical fiber according to the method of the present invention.

FIGS. 9A and 9B are micrographs depicting a substantially void-free microstructured optical fiber prepared according to the method of the present invention.

FIGS. 10A and 10B are micrographs further illustrating the ability of the method of the present invention to produce substantially void-free optical fibers compared to the methods of the prior art.

### DETAILED DESCRIPTION

The aspects and features of the present invention summarized above can be embodied in several different forms. The following description shows, by way of illustration, various combinations and configurations in which aspects and features of the invention can be put into practice. It is understood that the aspects, features, and/or embodiments described herein are merely examples, and that one skilled in the art may utilize other aspects, features, and/or embodiments or may make structural and functional modifications without departing from the scope of the present disclosure.

In describing optical fibers, the term “microstructured” is typically used to describe a structure with features on the micro scale (between approximately 1 μm and 1000 μm) and the term “structured” is typically used to describe features of any scale, including features smaller than, larger than, or the same size as “microstructured” features. In the present disclosure, the term “microstructured” is used in describing features of a “microstructured” optical fiber and the term “structured” is used in describing features of an optical fiber preform from which the “microstructured” optical fiber is drawn, regardless of the actual or approximate sizes of the features. This choice of language is for clarity only, and the terms “microstructured” and “structured” can be used interchangeably without departing from the scope of the present disclosure.

In addition, as used herein, a “tube” or “microtube” typically possesses one longitudinal capillary running through the entire length thereof A “cane” or “microcane” may possess no longitudinal capillaries, a single longitudinal capillary, or a plurality of longitudinal capillaries, and may also possibly possess other features such as a non-uniform refractive index profile or a solid or hollow core region. It may be noted that a “microtube” is by definition also a “microcane,” but a “microcane” is not required to also be a “microtube.” The tubes, microtubes, canes and microcanes may have arbitrary outer and inner transverse shapes and may be the product of a combination of various fabrication methods including extrusion, molding, rotational casting, stack and redraw, etc. For example, a “microtube” may be extruded and then stretched on a fiber draw tower and may possess a circular or hexagonal outer transverse shape, and a circular inner transverse shape. In some embodiments, a “cane” or “microcane” may itself be in essence a thin microstructured optical fiber, containing its own core, cladding, and jacket region, and may be fabricated using the method described in this disclosure. For simplicity, the method and apparatus of the present invention may often be described with respect to fibers constructed of preforms having a microstructured region comprising a plurality of “microcanes”; however, it will be appreciated by those skilled in the art that aspects of the invention described herein are equally applicable to fibers fabricated using one or more microcanes either alone or in combination with one or more microtubes.

As noted above, SC-PCF and HC-PBG microstructured optical fibers have been developed to improve the transmission and other properties of optical fibers, such as the transmission of specific desired wavelengths of light. These improved optical properties are the result of the specific structure of these fibers.

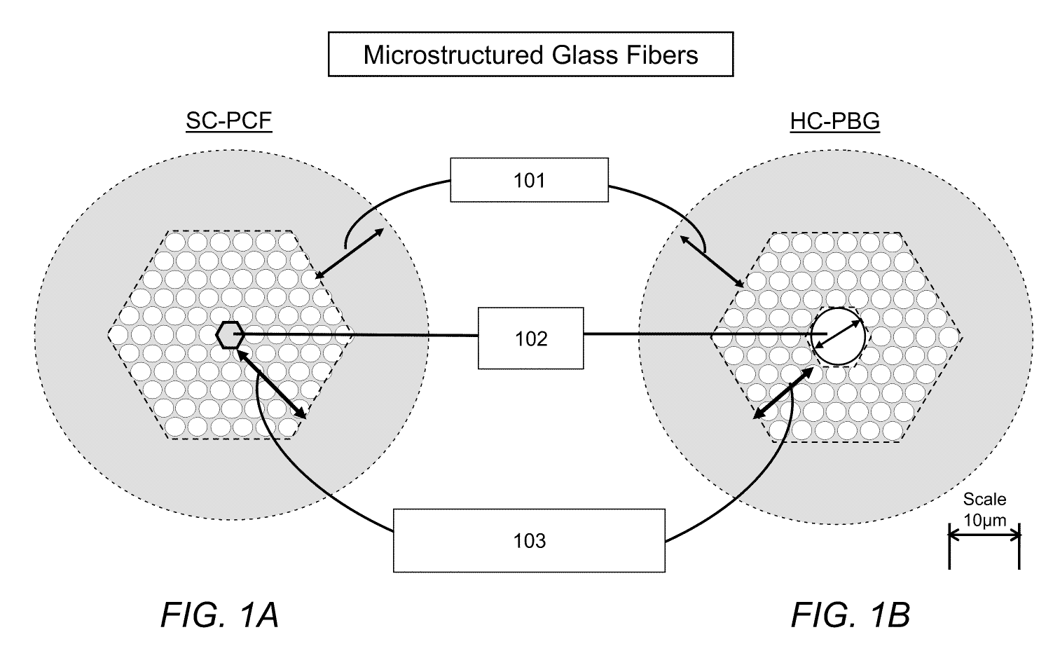

The cross-sections of the exemplary SC-PCF and HC-PBG microstructured optical fibers shown in FIGS. 1A and 1B illustrate the structure of these fibers. As seen in the Figures, both SC-PCFs (FIG. 1A) and HC-PBG fibers (FIG. 1B) comprise an outer layer of glass 101, a core 102, and a cladding 103 exhibiting a transversally periodic arrangement of glass and holes comprising longitudinal capillaries extending through the length of the fiber. In the description herein, one or more capillary in the fiber may also at times be referred to as a “hole” or an “air hole.” In addition, as used herein, “air” can include not only air but also can include other gases such as helium, nitrogen, or argon, while an “air hole” may contain air, other gases, or no gas at all, i.e., be a vacuum, and all such cases are within the scope of the present disclosure.

It is the distribution of glass and air (or, as noted above, other gases or vacuum) by the components of these regions that create the particular optical properties of each type of fiber.

In both SC-PCF and HC-PBG fibers, cladding 103 of the fibers is not solid as in conventional optical fibers, but is instead a microstructured region having a periodic arrangement of glass and air holes. Typically, the periodicity of the holes is on the scale of the wavelength of light. Because the cladding comprises both glass and air, the refractive index of the cladding region is different than it would be if the cladding were solid glass. In addition, by varying the number, size, and periodicity of the air holes, the refractive index of the cladding area can be tuned so that the fiber exhibits desired optical properties such as transmission of a desired wavelength of light.

As seen in FIG. 1A, in SC-PCFs, the inner core region 103 is made of solid glass. Because cladding 102 is not solid glass but is a combination of glass and air, cladding 102 has a lower average refractive index than the solid glass core it surrounds. Based on the same total internal reflection principles as conventional optical fiber, the solid core confines and guides the light traveling through the fiber. However, the much higher contrast between the indices of refraction of the core and the cladding in such SC-PCFs enables stronger confinement of the light and can create non-linear effects useful for optical devices. Since the effective refractive index of the cladding varies with wavelength, SC-PCFs can be made to transmit a single mode for a wide range of wavelengths simultaneously when the air fill fraction is about 40%, unlike conventional TIR fibers, whose single-mode operation is limited to a very narrow band of wavelengths for any specific design. For this reason, SC-PCFs are often referred to as “endlessly single-mode.” The core can be the same size as the air holes in the surrounding cladding or can be smaller or larger than the holes, as appropriate to provide the desired optical effects.

As seen in FIG. 1B, in HC-PBG fibers, the core 103 consists of an air hole that has a different size than the air holes in the surrounding cladding 102. This case presents exactly the opposite arrangement from the SC-PCF. In contrast to the SC-PCF, where the core has a higher index of refraction than the cladding, in the HC-PBG fiber shown in FIG. 1B, the air hole comprising core 102 will have a much lower index of refraction than the cladding 103 due to the presence of glass in the cladding region. In an HC-PBG fiber, the cladding 103 creates a photonic band gap that prevents light from propagating appreciably in the cladding 103, and so light is primarily confined to the lower index hollow core. It should be noted that although in an exemplary embodiment used to illustrate the concepts of the invention, the core region is filled with air, in other embodiments the “air hole” comprising the core 102 may be filled with another gas, such as, for example, nitrogen, helium, carbon dioxide, argon, or mixtures of such gases, or may also be under vacuum.

In addition, in both SC-PCF and HC-PBG microstructured fibers, there can be many variations on the configuration of the core. For example, the fiber can have one single core or multiple distinct cores, for example, to encourage interaction between separate signals confined to separate cores. In addition, the transverse shape of the one or more of the cores can have a round, elliptical, hexagonal, or another shape, and the one or more cores can have either the same or different shapes, for example, to impart a birefringence condition for maintaining the polarization state of the propagating signal.

For both SC-PCF and HC-PBG microstructured optical fibers, the periodicity of the holes, the air fill fraction of the cladding and the refractive index of the glass dictate the optical properties of the fiber. As used in the art, the term “air fill fraction” refers to the ratio of the cross-sectional area of the capillaries to the combined area of the capillaries plus the solid material, or equivalently, the ratio of the volume of the capillaries to the total volume (volume of the capillaries plus volume of the solid material), in the microstructured region. More specifically, when the hole shape and arrangement is regular, the air fill fraction of a specific microstructured optical fiber design can be defined algebraically as a function of the ratio of the hole radius, r, to the hole pitch, Λ. For example, the air fill fraction for a microstructured optical fiber with round air holes arranged periodically in a triangular lattice, equals

$${( \frac{r}{Λ} )}^{2} \times ( \frac{2 π}{\sqrt{3}} ) .$$

Similarly, for a SC-PCF or HC-PBG fiber with round holes in a square lattice, the air fill fraction equals

$${( \frac{r}{Λ} )}^{2} \times π .$$

If the air holes are not perfectly shaped or sized or are not arranged in a perfect lattice arrangement, the air fill fraction is not easily calculated but can be measured by computer.

In SC-PCF these parameters dictate the index contrast and therefore the allowed modes and their propagation constants. Some such fibers can be single-mode over a broad range of wavelengths, a property called “endlessly single-mode” that is unique to SC-PCF and not possible in conventional solid core fiber. In HC-PBG fibers, these parameters determine the position of the photonic band gap, i.e., namely the wavelengths of light that can be guided through the hollow core.

Thus, it is very important to maintain the intended glass-hole structure of the fiber, without the presence of unintended additional holes due to interstitial voids or the absence of intended holes due to collapse of one or more microcanes. The present invention provides a method and an apparatus that can achieve these results.

The method of the present invention starts with an assembled or “loose” structured preform described in more detail below, consisting of a jacket tube disposed around one or more glass microtubes or microcanes. As used herein, the term “loose” refers to the fact that the preform is assembled from inner and outer elements which may or may not be well fitting and the preform has not yet undergone a separate and subsequent heat treatment step so as to consolidate the loose-fitting elements of the preform into a consolidated preform in which the elements are bonded or fused to one another. The individual microcanes used in the preform may or may not be exactly or approximately the same size or possess the same inner and outer transverse shapes.

In some embodiments of the present invention, one or more of the jacket and the microcanes/microtubes may be made of a specialty non-silica glass. Suitable specialty glasses include chalcogenide glasses such as sulfides, selenides, tellurides and mixtures thereof, and chalcohalide glasses and other oxide glasses, including specialty silicates, germanates, phosphates, borates, gallates, tellurites, antimonates and mixtures thereof In addition, more than one glass may be used, for example, with the jacket being fabricated from one glass, one or more microcanes being fabricated from a second glass, and one or more other microcanes (and/or the core in the case of SC-PCFs) being fabricated from yet a third. One or more of these glasses may be a specialty glass or a non-specialty glass, and all of such combinations may be used to make microstructured optical fibers within the scope of the present disclosure.

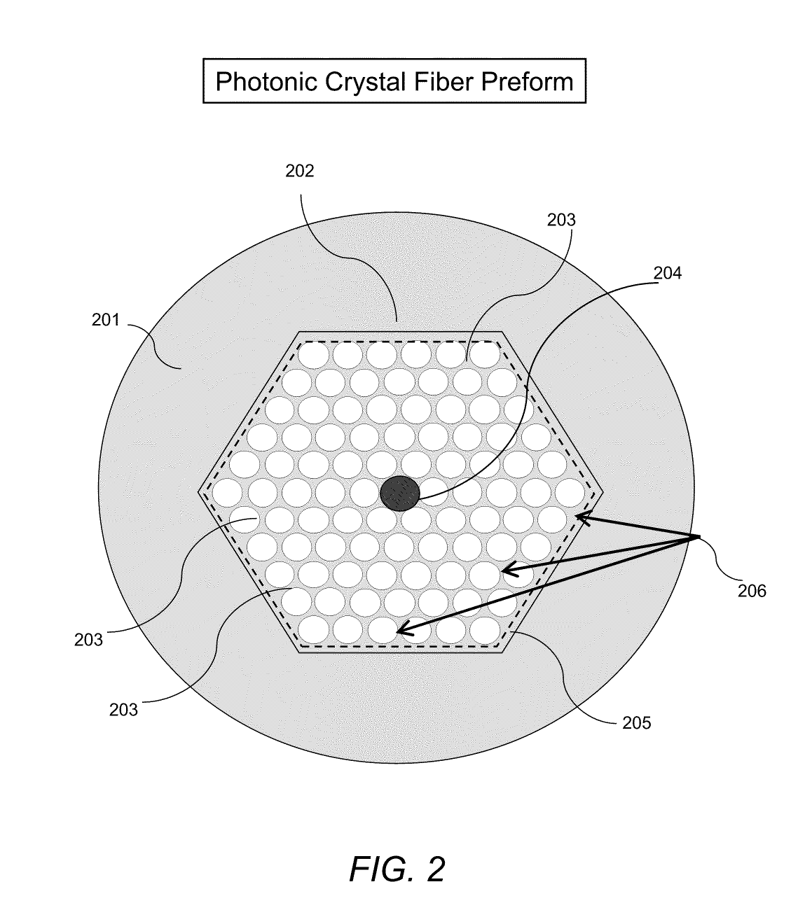

An exemplary general form of a structured preform for a microstructured optical fiber is shown in FIG. 2, and comprises an outer jacket 201, an inner structured region 202, and a central core 204 which, as noted above, can be solid glass in the case of a preform for an SC-PCF or can be a hollow space in the case of a preform for an HC-PBG fiber. A typical preform such as that illustrated in FIG. 2 has an outer diameter of about 10 mm to about 20 mm.

As shown in FIG. 2, the central structured region 202, also known as the cladding, typically is made by inserting a number of microcanes 203 into the supportive outer jacket 201 around a core 204. As noted above, the microcanes can comprise a number of solid and/or hollow structures (e.g., microtubes). The tubes comprising the microcanes 203 are stacked between the jacket and the core to form a periodic pattern of solid glass and holes in the microstructured region. In addition, in some embodiments, one or more solid microcanes can be inserted at the corners of the cladding region and can form solid “filler” regions in the microstructured fiber.

The accuracy of the periodicity and position of the intended holes in the microstructured region created by the microcanes 203 is critical to preventing optical coupling between the core and cladding in SC-PCFs and in attaining bandgap guidance in the HC-PBG fiber. This precision is adversely affected by incorrect tube positioning and tube slippage during fiberization, which are common deficiencies of the tube stacking method.

In addition, as shown in FIG. 2, a preform assembled in this way also inevitably will have one or more gaps, or “interfacial voids,” between the outer surfaces of adjacent microcanes or between an outer surface of a microcane and the jacket layer. These interfacial voids extend longitudinally through the entire length of the preform, and thus are connected to the ambient atmosphere outside the preform via the preform ends. Thus, as seen in FIG. 2, such interfacial voids 206 may occur at the interface between adjacent microcanes 203 or at the interface 205 between microcanes 203 and the supportive outer jacket tube. In some cases, these interfacial voids may be localized to a single pair of microcanes or to one or more microcanes and the jacket tube. In other cases, such interfacial voids may occur at the interface between several microcanes.

Conventional methods attempt to eliminate these voids through consolidation or some other heat treatment step before fiber drawing, wherein the space between the microcanes collapses thus eliminating the interfacial void. However, since the interfacial voids often have a size similar to those of the intended holes in the structured region of the preform, and run the entire length of the preform, it is difficult to eliminate such voids completely. This is especially true for specialty oxide and non-oxide glasses where the vapor pressure during fiberization may be sufficient to prevent collapse of these interstitial voids.

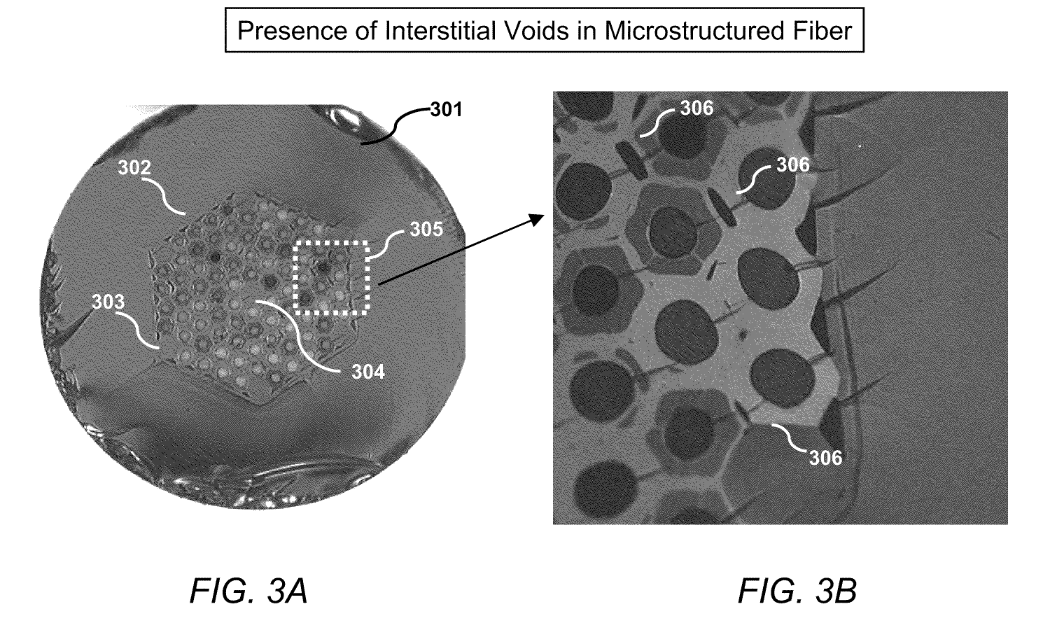

If the interfacial void does not collapse, it will become trapped in the final fiber, forming an “interstitial void” in the final fiber. Examples of optical fibers having such interstitial voids can be seen in FIGS. 3A and 3B. A micrograph of a microstructured optical fiber manufactured according to conventional methods is shown in FIG. 3A. The preform used to fabricate the fiber shown in FIGS. 3A and 3B was assembled and then consolidated using a separate and subsequent heat treatment step prior to the fiber drawing step. The fiber shown in FIG. 3A comprises a jacket region 301 having an outer diameter of approximately 150 μm, a hexagonal microstructured cladding region 302 comprising a plurality of longitudinal holes each having a diameter of approximately 7 μm, solid filler regions 303 at the corners of the cladding region, and single solid core 304 having a diameter of approximately 7 μm.

FIG. 3A also shows a highlighted region 305 which is shown in more detail in FIG. 3B. As seen in FIG. 3B, the fiber has numerous multiple micro-bubbles or interstitial voids 306 within the cladding region and between the cladding and jacket regions. These interstitial voids are voids in the fiber that are surrounded by glass, not connected to the atmosphere outside the fiber. Their size, position and frequency also varied along the length of the fiber. These voids are the result of the failure of the consolidation and heat treatment step to completely eliminate gas pockets from forming in the fiber.

The presence of such interstitial voids can have significant adverse effects on the final fiber. For example, interstitial voids in an HC-PBG fiber can compromise the photonic bandgap and prevent the efficient transmission of light through the fiber core because all of the light will scatter through the cladding and/or the jacket, with none of the light passing through the fiber in its intended path. In SC-PCFs, interstitial voids can cause the average refractive index of the fiber to vary; in such a case, mode fields of different diameters can experience different average cladding indices, which in turn can narrow the wavelength region for single-mode operation, can prevent single-mode operation entirely or, through scattering, can permit coupling of the optical to the jacket region, thereby reducing or eliminating transmission of the signal through the fiber in its intended path.

Consequently, it is desirable to eliminate voids from the preform before they become trapped as interstitial voids in the final fiber.

As noted above, conventional methods attempt to consolidate the preform before the fiber drawing step. However, it often is not possible to fully eliminate the interfacial gaps in the preform by such a method, and interstitial voids may still remain, either in the consolidated preform or in the final fiber.

The present invention provides a method and apparatus for fabricating SC-PCFs and HC-PBG fibers to prevent the formation of interstitial voids. In accordance with the present invention, microstructured optical fibers can be fabricated from loosely assembled (non-consolidated) structured preforms which are sequentially consolidated in-situ during the fiber drawing step. A microstructured optical fiber fabricated in accordance with the present invention will be substantially void-free and so will exhibit improved optical performance.

As described in more detail below, in the method of the present invention, a non-consolidated structured preform is placed into a fiber draw tower for drawing into the final fiber. The assembled preform is stretched, for example, on a fiber draw tower at a temperature corresponding to a glass viscosity in the range of about 10⁴ to 10⁶ Poises, into microstructured optical fiber with considerably smaller dimensions than the preform. The fiber outer diameter is typically less than about 1 mm and more typically less than about 500 μm, although a microstructured cane, with an outer diameter typically greater than about 1 mm, and more typically between about 1.5 and 4 mm, may also be fabricated by this method.

In accordance with the invention, the intended void regions (i.e., the holes in any hollow microcanes present) are isolated from the interfacial voids via a jig. As the fiber is drawn, negative gas pressure is applied to consolidate the preform and remove the interfacial gaps and prevent the presence of undesired voids while positive gas pressure is simultaneously applied to prevent collapse of the microcanes and ensure the presence of the desired holes in the microstructured region of the fiber. In some embodiments, the top of the microcanes can be fused together using, for example, a low surface-tension glue to ensure that the positive gas pressure applied to the microcanes to keep them open does not prevent the negative gas pressure from closing the gaps between the tubes. In other embodiments, the microcanes can be held open, for example, by rigid inserts made from quartz, stainless steel, fluoropolymer, polyetheretherketone (PEEK), ceramic, other polymers, other metals, other glasses placed therein, so that the negative gas pressure applied to close the gaps between the tubes does not collapse the microcanes during the draw process. In either case, the preform can be consolidated in-situ in the fiber tower and the fiber drawn in one step.

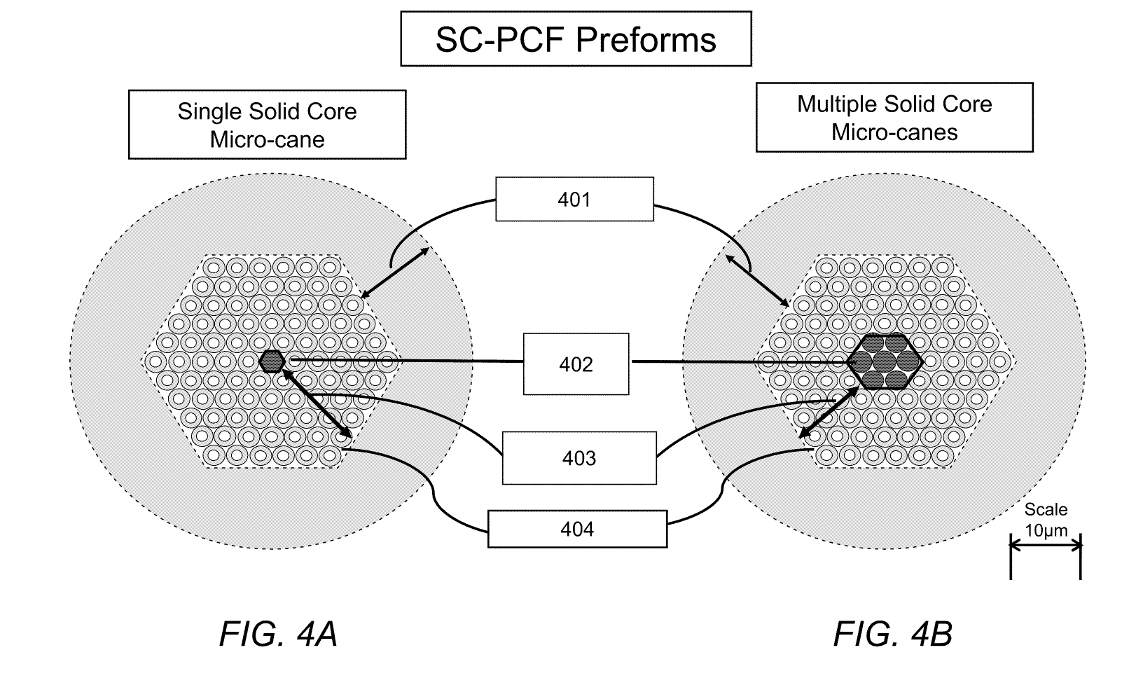

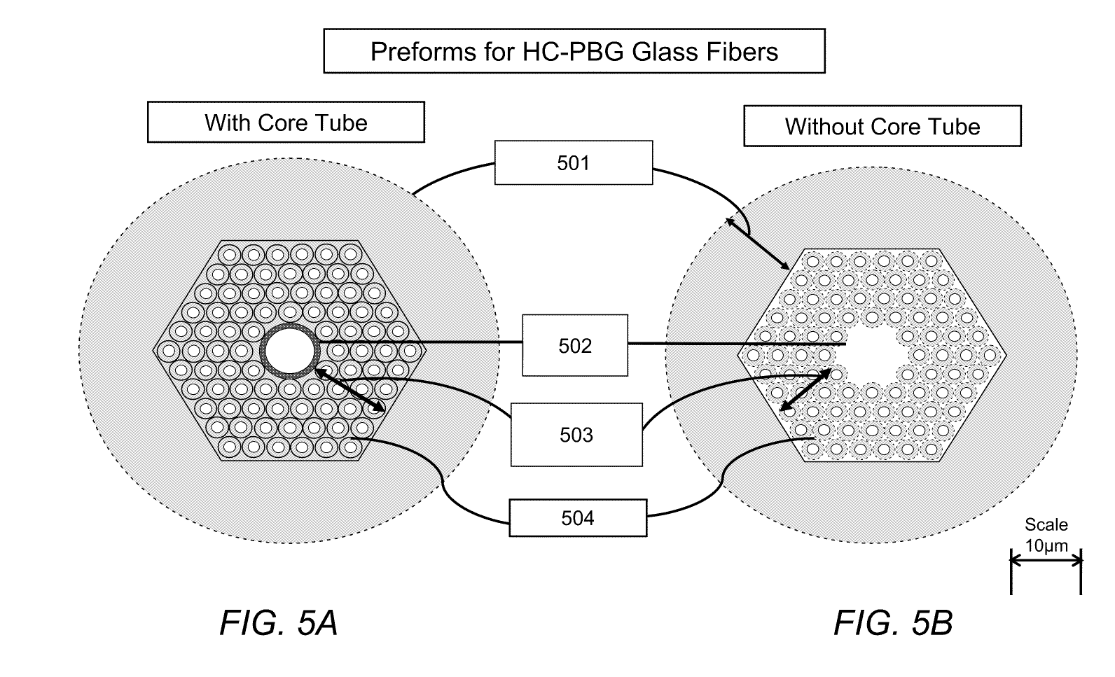

Exemplary preforms for SC-PCF and HC-PBG microstructured fibers suitable for use in the present invention are shown in FIGS. 4A-4B and 5A-5B.

FIGS. 4A and 4B are block diagrams of exemplary structured preforms for SC-PCF microstructured fibers suitable for use in the present invention. As shown in FIGS. 4A and 4B, a structured preform for an SC-PCF microstructured optical fiber comprises a jacket 401, a core 402, and a microstructured cladding 403 extending between the core and the jacket.

Jacket 401 comprises a solid glass material, and as described above, a suitable glass may comprise a specialty non-silica glass such as a chalcogenide glass or a chalcohalide glass. Its outer shape can be round, elliptical, hexagonal, or any other suitable shape. In addition, as shown in FIGS. 4A and 4B, core 402 may comprise a single solid core microcane (FIG. 4A) or multiple solid core microcanes (FIG. 4B), and also can have any suitable shape such as round, elliptical, or hexagonal. In the case of a core comprising multiple microcanes as shown in FIG. 4D, the microcanes 405 in the core can comprise one or more types of glass and each can have one or more different shapes as appropriate for the desired arrangement. Similarly, microstructured cladding 403 shown in FIGS. 4A and 4B can have any appropriate shape and comprise multiple microcanes arranged in a periodic pattern between the core and the jacket. In addition, as noted previously, microstructured cladding 403 can comprise many different combinations and arrangements of microtubes and microcanes having one or more of several different shapes and comprising one or more different types of glass. Irrespective of the number, arrangement, shape, or type of structures used in microstructured cladding 403, however, as described above, there will inevitably be gaps such as gap 404 either between one or more microcanes comprising cladding 403 or between cladding 403 and jacket 401. As described above, these gaps can create undesired interstitial voids in the final fiber.

Similarly, FIGS. 5A and 5B depict exemplary structured HC-PBG preforms suitable for use in the method of the present invention. Like the SC-PCF preforms shown in FIGS. 4A and 4B, a structured preform for an HC-PBG microstructured glass fiber shown in FIGS. 5A and 5B comprises a jacket 501 made of solid glass and a microstructured cladding 503 comprising a plurality of microtubes and/or microcanes 504 arranged in a desired periodic pattern, but instead of a solid core, has a hollow core 502. Hollow core 502 in the HC-PBG preform can include a core tube as shown in FIG. 5A or can be formed without a core tube as shown in FIG. 5B. If a core tube is used, just as with any microtubes in the microstructured cladding, the core tube can have any suitable shape such as circle, ellipse, or hexagon, can have a suitable inner and outer diameter, and can be made of the same or a different glass as the microtubes or the jacket. In addition, in accordance with the invention, any one or more of the jacket, microcanes, and core tube can be fabricated from a specialty glass such as a chalcogenide glass, a chalcohalide glass, or any other suitable non-silica glass.

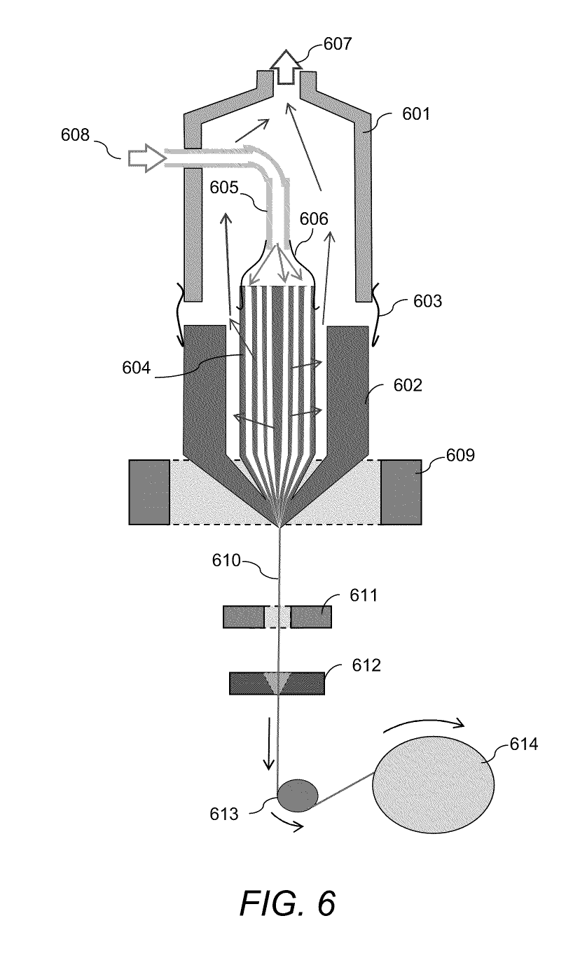

An exemplary embodiment of an apparatus for in-situ consolidation and drawing of a microstructured optical fiber according to the present invention is depicted in FIG. 6. The apparatus is designed to achieve the sequential consolidation of a loose structured preform as it is being drawn into an optical fiber, with the resulting fiber having the desired pattern of glass and holes but being substantially free of interstitial voids. The apparatus achieves this result by isolating the interfacial voids between the microstructures comprising the preform from the desired holes so that when negative gas pressure (i.e., a vacuum) can be applied to consolidate the preform and eliminate the interfacial voids, positive gas pressure can simultaneously be applied to prevent the collapse of the holes in the core and/or cladding.

As shown in FIG. 6, such an apparatus comprises a jig that can be used with a conventional draw tower. The apparatus of the present invention includes an outer tube 601 that can be attached to jacket 602 of the microstructured fiber preform and an inner tube 605 attached to the microstructured cladding 604. The connection between outer tube 601 and jacket 602 is sealed via seal 603 to ensure that proper positive and negative pressures are maintained throughout the preform during the consolidation of the preform and drawing of the fiber. In an exemplary embodiment, outer tube 601 is made of quartz, although other suitable materials may be used. In an exemplary embodiment, inner tube 605 is made of polytetrafluoroethylene (PTFE), although other suitable materials such as quartz, stainless steel, fluoropolymer, polyetheretherketone (PEEK), ceramic, other polymers, other metals, or other glasses may also be used. The connection between inner tube 605 and cladding 604 is sealed via seals 606 applied to the outermost surface of the cladding. Seals 603 and 606 may be made of heat-shrink TEFLON or any other suitable material that provides an airtight seal that will improve with the addition of heat and pressure. Thus in this way the entire preform is sealed so that no gases can enter or exit the preform except via tubes 601 or 605.

In the method for a one-step in-situ consolidation and drawing of a microstructured optical fiber of the present invention, negative gas pressure 607 and positive gas pressure 608 are applied to the outside and the inside, respectively, of the microstructured portion 604 of the preform. The negative gas pressure, i.e., vacuum, acts to draw the individual microtubes comprising the microstructured cladding together, thus eliminating the interfacial voids between the microtubes, while at the same time the positive gas pressure prevents the microtubes from collapsing due to the vacuum. While these negative and positive gas pressures are being applied, a radially compressive stress may also be applied to the jacket tube to further assist the in-situ consolidation. The pressures applied, whether positive, negative, or radial, can range from 0.03 to 10 psi.

As described in more detail below, in accordance with the present invention, as the preform is being consolidated, it is also drawn through the draw furnace 609 to produce the drawn fiber. The negative gauge pressure at the microtube-microtube interfaces and the microtube-jacket tube interfaces, combined with surface tension and positive gauge pressure inside each of the microtubes which may be applied using the jig, acts to sequentially consolidate the interfacial void region of the preform in-situ as it is drawn through draw furnace 609, thereby preventing the creation of interstitial voids in the drawn fiber.

The remainder of the drawing process is according to conventional methods, with the microstructured fiber 610 guided through LaserMike non-contact measurement system 611 and polymer coater 612, over capstan 613, and onto drum winder 614.

The resulting microstructured optical fiber prepared using the apparatus and method thus described is substantially free of interstitial voids and deformed micro-holes and therefore demonstrates lower transmission loss and better power handling than glass fibers made using conventional methods.

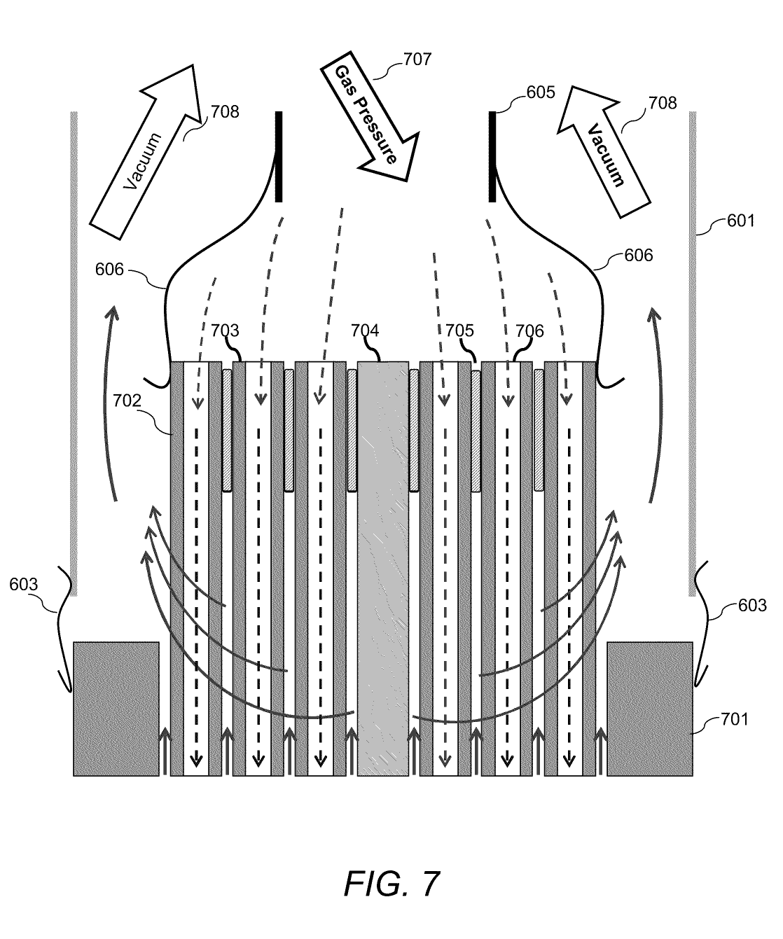

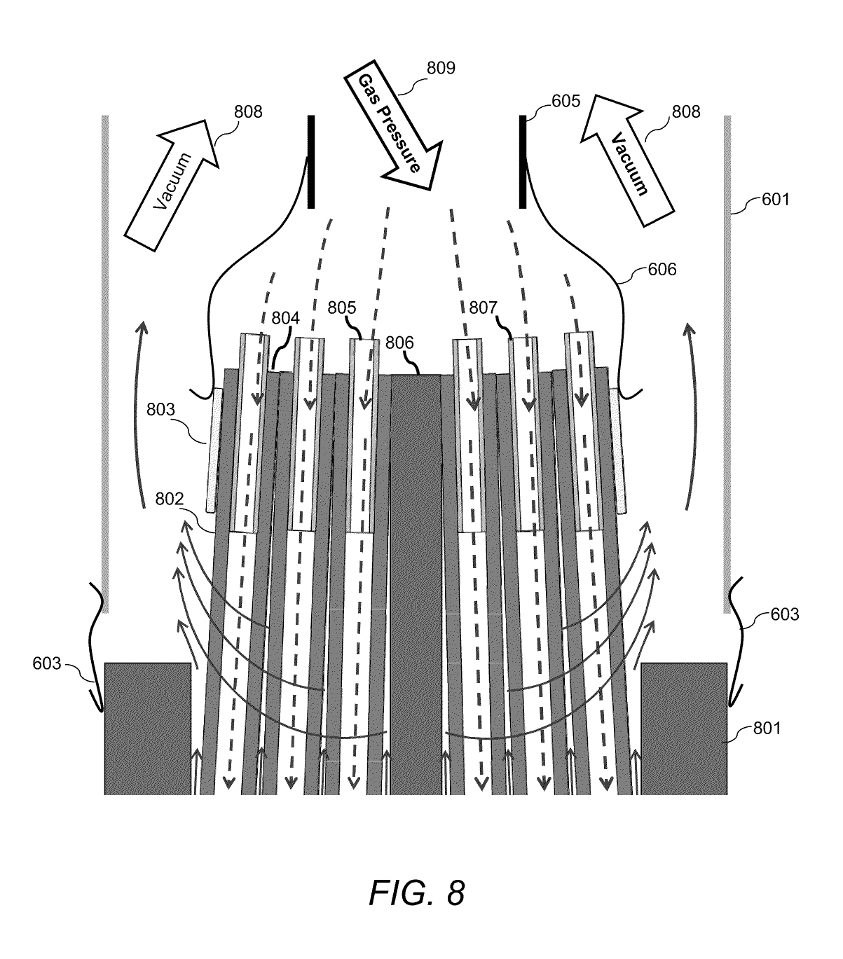

FIGS. 7 and 8 depict exemplary embodiments of the way in which structured preforms for microstructured optical fibers such as those described above can be consolidated in-situ and drawn into substantially void-free microstructured optical fibers using the apparatus and method described herein. Although the preforms depicted in FIGS. 7 and 8 are those for a SC-PCF, it can easily be appreciated that the description below applies equally to HC-PBG fibers with only minor modifications.

In a first exemplary embodiment shown in FIG. 7, a loose structured preform for a SC-PCF such as the preforms shown in FIGS. 4A-4B is secured within the apparatus shown in FIG. 6. As shown in FIG. 7, the core and microstructured portion of the preform extend above the top of the jacket so that the core/microstructured portion of the preform can be isolated from the jacket and separately secured to the apparatus.

Thus, as shown in FIG. 7, using reference numerals from FIG. 6 as appropriate to refer to components of the apparatus, exterior tube 601 is secured to jacket tube 701 of the preform via seals 603. The microstructured cladding 702 of the preform, comprising a plurality of microtubes and/or microcanes 703 and a core microcane 704 (in the case of a SC-PCF fiber preform) is secured to inner tube 605 via seals 606 applied to the outermost surface of the cladding. In accordance with the method of the present invention, positive gas pressure 707 is applied to the openings 706 of the core/microstructured region via inner tube 605 while negative gas pressure, i.e., vacuum pressure 708, is simultaneously applied to the entire preform via outer tube 601. As noted above, the pressure applied can range from about 0.03 to about 10 psi. The application of the vacuum pressure consolidates the preform, removing any air trapped between the microcanes 703, between the microcanes 703 and the jacket 701, or between the microcanes 703 and the core 704, while the application of positive gas pressure 707 prevents the centers 706 of the microcanes from collapsing, ensuring the retention of the desired hole structure of the microstructured region. In addition, so that the positive gas pressure 707 cannot counteract vacuum pressure 708 and prevent the removal of air from the preform, the top of the space between each of microcanes 703 is sealed with a sealant 705 such as a low surface tension glue or other suitable material. As seen in FIG. 7, only the top of the space is sealed, with the remainder of the space being left open to the application of the vacuum pressure. Thus, in the method of the present invention, as the preform is in the draw tower, the air in any interfacial gaps in the preform is removed by the application of negative gas pressure while the desired hole structure is maintained by the application of positive gas pressure, so that the preform is sequentially consolidated as it is being drawn, resulting in a substantially void-free microstructured optical fiber.

FIG. 8 depicts a second exemplary embodiment of a microstructured fiber in-situ consolidation and draw process according to the present invention. As with the embodiment shown in FIG. 7, outer tube 601 of the apparatus is secured to jacket tube 801 via seals 603 and core/microstructured cladding 802, comprising microcanes 804 and core 806, is secured to an inner tube 605 via seals 606. However, in this embodiment, seals 606 do not attach directly to the outermost surface of microstructured cladding 802 but instead attach to a suitable intermediate layer 803 comprising, for example, heat-shrink TEFLON, secured to microstructured cladding 802. In addition, instead of using glue to seal the top of the spaces between the microtubes as shown in FIG. 7, in the embodiment shown in FIG. 8, rigid tubes 807 are inserted into the microcanes 804 to ensure that clamping force from the intermediate layer 803 does not close the holes 805 in the microcanes while gas pressure 809 is applied to the openings 805 and vacuum 808 is applied to the outside of the microcanes 804, the solid core microcane 806, and the inside of the jacket tube 801 to consolidate the preform. As with the embodiment in FIG. 7, the preform is thus sequentially consolidated as it is being drawn, resulting in a substantially void-free microstructured optical fiber.

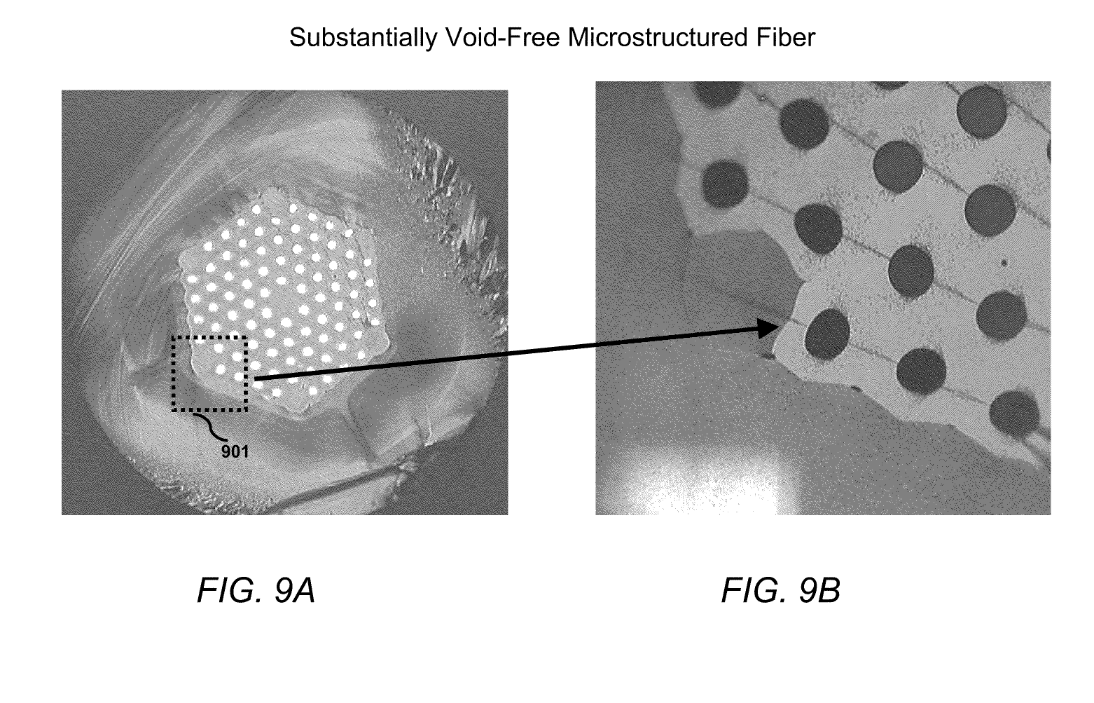

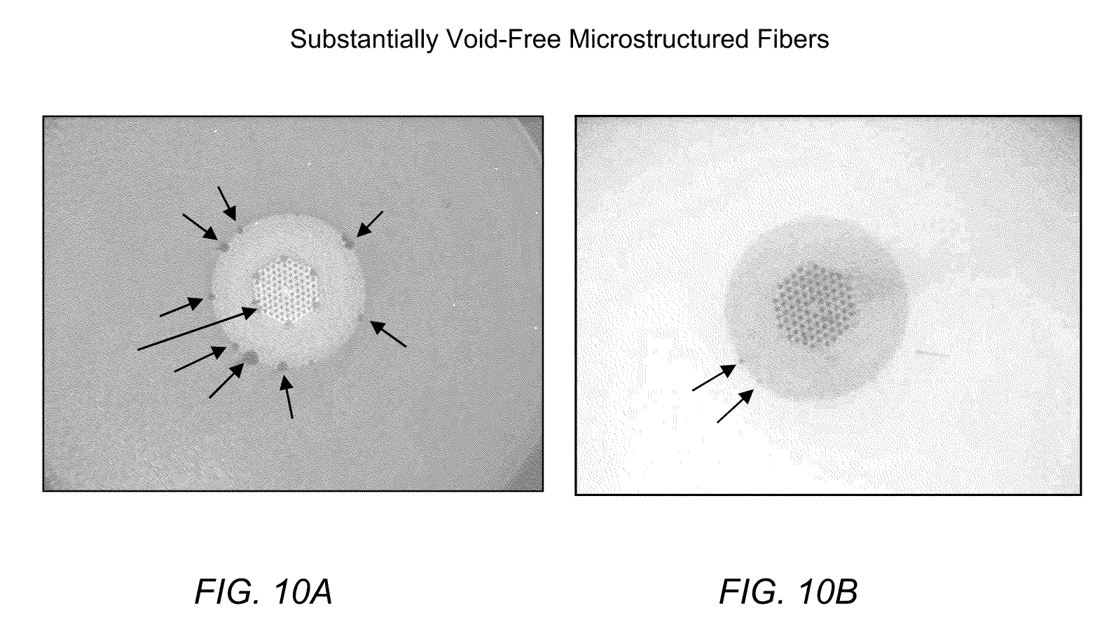

FIGS. 9A-9B and 10A-10B present micrographs of the substantially void-free microstructured optical fibers produced using the apparatus and method described herein. FIG. 9A depicts a microstructured optical fiber fabricated according to the present invention. There are no readily visible voids in this fiber, even in the close-up view shown in FIG. 9B. This is in stark contrast to the fiber shown in FIG. 3A, which exhibits several voids in area 305 that are visible even before being shown in the close-up of FIG. 3B. Similar improvement in the fiber is illustrated in the micrographs shown in FIGS. 10A and 10B. The micrograph of FIG. 10A shows a microstructured fiber fabricated using conventional preform consolidation methods, which exhibits several voids between the inner and outer jackets, as shown by the numerous arrows in FIG. 10A. In contrast, the microstructured optical fiber prepared using the in-situ vacuum-assisted preform consolidation fiber draw method of the present invention shown in FIG. 10B has appreciably fewer and smaller voids, as shown by the arrows in FIG. 10B.

The improved microstructured optical fibers produced using the apparatus and method of the present invention will have an impact in both military and civilian applications.

For example, SC-PCFs can be used in a variety of non-linear optical devices including devices for wavelength translation, supercontinuum generation, etc. SC-PCF-based non-linear optical devices may replace crystal devices in some applications reducing cost, weight, and system complexity.

HC-PBG fibers can be used as sensors in facility clean up, biomedical analysis (e.g. glucose, blood, breath etc), CBW agent detection, toxic and hazardous chemical detection, and environmental pollution monitoring and process control, etc. In addition to chemical sensing, the HC-PBG fibers can be used for very high laser power delivery since the light is predominantly guided in the hollow core, unlike in traditional fibers which possess a solid core that will damage at high powers. In addition, HC-PBG fibers can also reduce system cost, weight, and complexity, and canenabe remoting of high power lasers for industrial applications such as cutting, welding, metrology and for biomedical applications such as laser surgery, cancer removal and glaucoma treatment.

In either case, the method and apparatus of the present invention will improve the performance and reliability of these fibers and reduce the difficulty of their fabrication, particularly in SC-PCF and HC-PBG fibers made from non-silica specialty glasses.

It is particularly anticipated that the method of fabricating microstructured optical fibers described herein will be used in the fabrication of fibers comprising one or more specialty non-silica glasses such as chalcogenide glasses, including sulfides, selenides, tellurides, and their mixtures, as well as chalcohalide glasses and other oxide glasses, such as specialty silicates, germanates, phosphates, borates, gallates, tellurites, antimonates and their mixtures. Chalcogenide glasses enable transmission from about 1 μm to 11 μm in microstructured optical fibers and so are particularly suitable to provide the optical properties desired for such fibers.

Although particular embodiments, aspects, and features have been described and illustrated, it should be noted that the invention described herein is not limited to only those embodiments, aspects, and features.

For example, the method of fabricating microstructured optical fibers by drawing assembled preforms with in-situ vacuum-assisted consolidation is not limited to the types of structures shown in the Figures, but can also be used for more complex structures. Thus, the method can also be applied to structures having microtubes with outer transverse shapes other than round or hexagonal or jacket tubes with different inner transverse shapes, for example, to microstructured fibers having holes in a square lattice arrangement.

Other alternative embodiments could include the use of solid micro-canes instead of micro-tubes to fabricate a solid fiber with multiple distinct cores. Furthermore, there is no constraint on uniformity in size or transverse shape of the individual micro-tubes or micro-canes, i.e. sizes and shapes can vary as appropriate for a desired arrangement of holes or features in a microstructured fiber.

It should be readily appreciated that these and other modifications may be made by persons skilled in the art, and the present application contemplates any and all modifications within the spirit and scope of the underlying invention described and claimed herein.

What is claimed is:

1. A method for manufacturing a microstructured optical fiber, comprising:
assembling a preform comprising a solid outer jacket, an inner core, and an intermediate cladding between the jacket and the core, the cladding including a plurality of glass microcanes arranged in a desired periodic pattern, the plurality of microcanes including at least one microtube having at least one longitudinal opening extending through the entire length thereof, the cladding and the core extending beyond an upper surface of the jacket, the preform including at least one interfacial void comprising a gap in the preform, the gap being one of a gap between adjacent microcanes and a gap between a microcane and the cladding;
placing the assembled preform into a jig connected to a draw tower, the jig including an outer tube connected to a source of negative gas pressure and an inner tube connected to a source of positive gas pressure;
securing the outer tube of the jig to an outer surface of the jacket so that the entirety of the preform is within the outer tube;
securing the inner tube of the jig to an outer surface of the cladding so that the cladding and the core of the preform is within inner tube;
applying negative gas pressure to the preform via the outer tube to remove air from the at least one interfacial void and prevent the formation of interstitial voids in the microstructured optical fiber;
applying positive gas pressure to the cladding and the core via the inner tube to prevent collapse of the at least one longitudinal opening, the negative and positive gas pressure being applied to sequentially consolidate the preform as it is being drawn into the optical fiber; and
drawing the consolidated preform into the microstructured optical fiber, wherein the drawn fiber retains the at least one longitudinal opening and is substantially free from interstitial voids.

2. The method according to claim 1, wherein the cladding includes a plurality of microtubes forming a desired periodic pattern of glass and holes; and further wherein the drawn optical fiber retains the desired periodic pattern.

3. The method according to claim 1, wherein the microstructured optical fiber is a solid-core photonic crystal fiber (SC-PCF), wherein the core in the preform comprises a solid glass microcane.

4. The method according to claim 1, wherein the microstructured optical fiber is a hollow-core photonic band-gap (HC-PBG) fiber.

5. The method according to claim 4, wherein the core of the HC-PBG fiber in the preform comprises at least one glass microcane having at least one longitudinal opening extending through the entire length thereof; and
further wherein the application of the positive gas pressure during consolidation of the preform prevents collapse of the core.

6. The method according to claim 4, wherein the core of the HC-PBG fiber comprises a longitudinal opening surrounded by the cladding; and
further wherein the application of the positive gas pressure during consolidation of the preform prevents collapse of the core.

7. The method according to claim 1, further comprising sealing the top of the gap before applying the positive and negative gas pressures;
wherein the positive gas pressure does not extend into the gap to interfere with the ability of the negative gas pressure to remove the at least one interfacial void in the preform as it is being consolidated.

8. The method according to claim 1, further comprising:
placing a rigid insert in the top of the at least one longitudinal opening in the at least one microtube;
wherein rigid tube prevents the collapse of the at least one longitudinal opening in the preform.

9. The method according to claim 8, wherein the rigid insert comprises one of quartz, stainless steel, fluoropolymer, polyetheretherketone (PEEK), ceramic, and polymer.

10. The method according to claim 1, wherein the inner tube is secured to an intermediate sealing surface on the exterior surface of the cladding.

11. The method according to claim 9, wherein the intermediate sealing surface comprises heat-shrink TEFLON.

12. The method according to claim 1, wherein the outer and inner tubes are sealed by means of heat-shrink TEFLON.

13. The method according to claim 1, wherein at least one of the jacket, cladding, and core comprises a non-silica glass.

14. An apparatus for consolidating a preform for a microstructured optical fiber, the preform comprising an outer jacket, an inner core, and an intermediate cladding between the jacket and the core, the cladding comprising a plurality of microcanes arranged in a desired periodic pattern, at least one of the microcanes comprising a microtube having at least one longitudinal opening extending through the entire length thereof, the cladding and the core extending beyond an upper surface of the jacket, the preform including at least one interfacial void, the apparatus being operatively connected to a draw tower for drawing the preform into an optical fiber, the apparatus comprising:
an outer tube connected to a source of negative gas pressure and configured to sealingly fit around an outer surface of an exterior jacket of the preform;
an inner tube connected to a source of positive gas pressure and configured to sealingly fit around an outer surface of a cladding of the preform, the cladding extending above an upper surface of the jacket so that the cladding can be sealed within both the inner and the outer tube;
wherein negative gas pressure is applied to the preform via the outer tube to remove air from at least one interfacial void and prevent the formation of interstitial voids in the microstructured optical fiber;
wherein positive gas pressure is applied to the cladding and the core via the inner tube to prevent collapse of at least one longitudinal opening, the negative and positive gas pressure being applied to sequentially consolidate the preform as it is being drawn into the optical fiber.

15. The apparatus according to claim 14, wherein the outer tube comprises quartz.

16. The apparatus according to claim 14, wherein the inner tube comprises one of quartz, stainless steel, fluoropolymer, polyetheretherketone (PEEK), ceramic, and polymer.

17. The apparatus according to claim 14, wherein the outer and inner tubes are secured to the preform by means of seals comprising heat-shrink material.

18. The apparatus according to claim 16, wherein the seals comprise heat-shrink TEFLON.

19. A microstructured optical fiber, comprising:
a solid outer jacket, an inner core, and an intermediate cladding disposed between the jacket and the core, the cladding comprising a plurality of solid regions and holes arranged in a desired periodic pattern;
wherein the microstructured optical fiber is drawn from a preform which has been consolidated in-situ on a draw tower by simultaneous application of negative and positive gas pressure on the preform to remove interfacial voids from the preform and prevent formation of interstitial voids in the fiber.

20. The microstructured optical fiber according to claim 19, wherein at least one of the jacket, core, and cladding is made from a non-silica glass.

21. The microstructured optical fiber according to claim 20, wherein the non-silica glass includes one of a chalcogenide glass, a chalcohalide glass, an oxide glass comprising specialty silicates, germanates, phosphates, borates, gallates, tellurites, and antimonates, and mixtures thereof.

22. The microstructured optical fiber according to claim 19, wherein the fiber comprises a solid-core photonic crystal (SC-PCF) fiber.

23. The microstructured optical fiber according to claim 19, wherein the fiber comprises a hollow-core photonic band-gap (HC-PBG) fiber.

24. The microstructured optical fiber according to claim 23, wherein the core of the HC-PBG fiber is fabricated from at least one microcane having at least one longitudinal opening extending through the entire length thereof.

25. The microstructured optical fiber according to claim 23, wherein the core of the HC-PBG fiber comprises a hollow space surrounded by the cladding.

26. The microstructured optical fiber according to claim 19, wherein the cladding is fabricated from a plurality of microcanes forming the desired periodic pattern of solid regions and holes; and further wherein the drawn optical fiber retains the desired periodic pattern.

27. The microstructured optical fiber according to claim 19, wherein each of the jacket, cladding, and core comprises a different glass.

28. The microstructured optical fiber according to claim 19, wherein the cladding is fabricated from a first plurality of microcanes consisting of a first non-silica glass and a second plurality of microcanes consisting of a second non-silica glass.

29. The microstructured optical fiber according to claim 19, wherein the holes have a shape including at least one of circular, oval, and hexagonal.
